(19) United States
(12) Patent Application Publication
(10) Pub. No.: US 2004/0120871 A1
(43) Pub. Date: Jun. 24, 2004

(54) Reactor construction

(76) Inventors: Gilbert De Angelis, Lindley, NY (US); Scott W. Deming, Elmira, NY (US); Jerome T. Firlik, Big Flats, NY (US); Michael G. Shultz, Big Flats, NY (US)

Correspondence Address: CORNING INCORPORATED, SP-TI-3-1, CORNING, NY, 14831

(21) Appl. No.: 10/411,053

(22) Filed: Apr. 10, 2003

Related U.S. Application Data
(60) Provisional application No. 60/436,260, filed on Dec. 19, 2002.

(51) Int. Cl. B01J 8/02

(52) U.S. Cl. 422/222; 422/190; 422/211

(57) ABSTRACT

A chemical reactor for catalytically processing a fluid feed stream comprises a reactor vessel incorporating a structured catalyst bed, and additionally comprises one or more catalytically active, fluid-permeable seals provided in gaps between the catalyst bed and the walls of the reactor vessel to treat portions of the fluid feed stream otherwise by-passing the structured catalyst for treatment.

This application claims the benefit of U.S. Provisional Application No. 60/436,260, filed Dec. 19, 2002, entitled “Reactor Construction”, by Deming et al.

### BACKGROUND OF THE INVENTION

The present invention relates to catalytic reactor vessels and, more particularly, to an improved chemical reactor vessel containing structured catalysts for treating fluid feed streams that are sealed within the reactor vessel walls by means of fluid-permeable seals.

Chemical reactors utilizing heterogeneous catalysts are generally constructed as walled reactor vessels containing randomly packed beds of relatively small catalyst particles, e.g., catalyst beads or pellets of sizes ranging from millimeter or sub-millimeter to centimeters in bead or pellet diameter. Fluid flow through these reactors, especially flow comprising two-phase gas and liquid streams, is often non-uniform and inefficient.

For maintenance purposes it is common practice to have to periodically replace the catalyst pellet beds with fresh materials. This procedure is very expensive, and adds significantly to the costs of reactor operation.

For the above reasons interest is growing in the use of chemical reactors comprising structured catalyst beds. Structured catalysts typically comprise shaped monolithic bodies or so-called monoliths, generally of dimensions substantially larger than beads or pellets, that comprise flow-through channels or other open internal void spaces through which a feed stream to be catalytically processed may flow. Catalytic material is provided on or within the internal walls defining the channels or voids for treating the feed stream as it traverses the structure. The more efficient monolith designs, such as catalyst-bearing honeycomb structures, provide both larger geometric surface areas and lower pressure drops for the processing of feed streams traversing the reactors.

The characteristics of catalytic honeycomb structures are particularly beneficial for reactions currently carried out in trickle bed and slurry reactors. Thus such structures are useful in a wide variety of catalytic processes involving feed stream processing through pelletized catalyst beds, in both counter-flow and co-current flow modes and in any of a variety of conventional flow regimes including so-called Taylor flow, slug flow or turbulent flow feed stream processing modes.

Honeycomb monoliths for structured catalysts can be formed of any of a wide variety of materials including polymers, metals, glasses and ceramics. In the case of ceramic honeycomb monoliths, the structures can be formed by extrusion, either from batches that include active catalysts or catalyst precursors, or from catalyst support materials such as cordierite or alumina that can be catalytically activated or coated with a wash coating and catalyzed with an active material. Present monolith fabrication processes generally limit the production length and diameter of extruded ceramic honeycombs, but smaller honeycombs can easily be assemble via cementing or mechanical interlocking into monoliths of essentially any desired size.

One of the requirements to be met in the development of chemical reactors employing structured catalyst beds is that of mounting monoliths within reactor containment vessels in a manner that is effective to avoid by-pass of the catalyst bed by portions of the feed stream. Thus it is important to confine or restrict feedstream flow to the channels or voids within the structured catalyst.

Conventional reactor vessels are not constructed to close dimensional tolerances. Vessel walls are frequently out of round, and interior wall surfaces joined by welding may retain slag on seam welds that is rough and protrusive. Further, the sum of tolerances in the catalyst monolith stack, including those arising from the use of multiple monolith layers and layers of slightly varying radial dimensions as measured center of each layer outwards, will change depending upon variations in part size and/or assembly gaps. Thus, spaces between elements of a monolith catalyst stack and stack containment vessels are difficult to avoid, and in fact are generally variable about the circumference of the vessel and from layer to layer in a stack.

To resolve the above difficulties, it has been proposed to use cements or other sealing materials to seal peripheral spaces surrounding structured catalyst beds against feed stream by-pass along the wall of reactor vessels. However, sealing approaches such as these present new problems, including the difficulty of forming seals offering prolonged service life and limited availability of sealing materials that can conform to the changing gap dimensions that will occur as temperatures inside the reactors cause varying degrees of thermal expansion in the reactor vessels and catalysts.

### SUMMARY OF THE INVENTION

The present invention provides a new, more efficient catalytic reactor construction. The new construction is applicable to walled vessels filled with structured monolithic catalyst beds. For the purposes of the present description a structured catalyst bed is a catalyst bed comprising on or one or more monolithic structures comprising open voids or other through-channels traversing the structures and bounded by interior walls formed of or supporting one or more catalysts for the treatment of fluid feed streams passing through the structures. The fluid feed streams may comprise liquids, gases, or combinations of liquids and gases.

The chemical reactor construction of the invention features a catalytic reactor comprising a structured catalyst bed mounted within a walled reactor vessel comprising an inlet and an outlet for processing a fluid reactant feed stream. In addition to the structured catalyst bed the reactor comprises one or more peripheral catalyst bed seals, positioned between the catalyst bed and the reactor vessel wall, that act to restrict by-pass of the catalyst bed by the reactant feed stream.

Rather than consisting of a fluid-tight seal, the catalyst bed seals of the invention are fluid-permeable, catalyst-containing supporting seals. More specifically they are seals formed of a particulate catalyst, e.g., a bead, pellet, granular or powdered catalyst, and preferably a catalyst that is similar in catalyst composition, or at least in catalyst function, to the catalyst provided within the structured catalyst bed.

In a first aspect, then, the invention includes a chemical reactor having a structure comprised of a vessel enclosed by walls and containing a structured catalyst bed, wherein at least one fluid-permeable, catalyst-containing seal is provided within one or all gap spaces between the structured catalyst bed and the vessel. The seal will generally consist of a particulate catalyst that fills peripheral gap spaces around at least one layer of the structured catalyst bed, thus restricting fluid by-pass through the reactor while still being effective to process fluid feed traversing the seal. By a particulate catalyst is meant a pelletized, beaded, granular or powdered material consisting of or supporting a catalyst effective to treat the fluid by-passing the structured catalyst.

Among its various advantages, the sealing approach of the invention greatly simplifies and facilitates reactor loading and re-loading, since fitting to or removing permanent sealing materials is not required. Further, the shaping or fitting of structured catalyst bed layers or layer components to close dimensional tolerances, or to accommodate reactor beds of various sizes, or of rough interior wall finishes or dimensions, is not required.

The particulate sealing materials used to provide these seals may be added in quantities sufficient to fill all gap spaces within the reactor, or they may be added selectively. For example, discrete circumferential layers of particulate catalyst may be positioned about the peripheries of all or only some selected monolith layers making up the structured catalyst bed of the reactor.

In either case, it is useful in many cases to provide supports within the gap spaces to prevent or retard the settling or compaction of the particulate catalyst during reactor operation. Most desirably the supports will be flexible supports, consisting, for example, of flexible circumferential flange elements supported by and extending from the monolith layers toward the walls of the reactor vessel. Thin flange extensions projecting inwardly into the monolith column between monolith layers can provide adequate support.

Such circumferential flange elements can accommodate wide variations in structured catalyst element size or shape, as well as compensate for dimensional changes in the reactor vessel or the catalyst monoliths that may occur with aging or temperature swings during reactor operation. Whether reactor gap spaces are fully or only partly filled with particulate catalyst, the flexibility of the supports can help prevent the caking of catalyst particles as well as eliminate seal cracking and fissures during expansion and contraction cycles.

In a further aspect the invention includes an improved method for the catalytic processing of a fluid feed stream in a chemical reactor incorporating a structured catalyst. In accordance with that method, a principal portion of the fluid feed stream to be treated is transported through the structured catalyst disposed within the reactor vessel in a conventional manner. At the same time, a by-pass portion of the feed stream is transported through a catalytically active, fluid-permeable seal positioned in gaps between the walls of the reactor vessel and the structured catalyst. The catalytically active, fluid permeably seal is a layer of particulate, e.g., granular, beaded or pelletized catalyst filling the gaps around one or more layers of the structured catalyst. Thus the by-pass of unprocessed feed through the reactor is substantially avoided without the need to employ expensive measures to seal the feed steam flow path completely against by-pass.

### BRIEF DESCRIPTION OF THE DRAWINGS

Further aspects and/or specific examples of the invention are shown in more detail in the appended drawings, not presented in true proportion or to scale, wherein:

FIG. 1 is a schematic plan view of a known type of reactor vessel incorporating a structured catalyst;

FIGS. 2a and 2b present schematic elevational and plan views, respectively, of a reactor provided with a by-pass seal in accordance with the invention; and

FIG. 3 is a schematic partial cutaway view of a section of a reactor incorporating a supported by-pass seal.

### DETAILED DESCRIPTION OF THE INVENTION

While any of a variety of structured catalyst beds may be employed in the reactors of the invention, the preferred structured catalysts are monolithic honeycomb catalysts, i.e., honeycomb monoliths or assemblies of honeycomb monolith sections comprising through-channels bounded by channel walls formed of or supporting an active catalyst. An example of such a bed is a bed made up of one or several honeycomb monolith layers, each layer comprising one or a plurality of commercially available ceramic honeycomb monoliths cemented together about their outer edges. The honeycomb channels in the cemented assembly are all parallel to a common axis, which is the axis of fluid flow through the monolith layer.

Subassemblies of such cemented monoliths may be further cemented together to form monolith layer assemblies of any desired diameter and shape. The assembled monolith layers are then stacked within the walls of the reactor vessel, with particulate catalyst being loaded around the layer periphery to provide the fluid permeable by-pass seal.

Honeycomb monoliths suitable for constructing such assemblies may be formed of any of the various conventional metallic, ceramic, composite, or other materials useful as catalysts or catalyst supports. Examples of specific honeycomb materials useful for the purpose include zeolite, cordierite, alumina, zirconia, spinel, mullite, silica, carbon, and various catalytically active metal oxides, most typically oxides or oxide mixtures of the transition metals. Catalysts or supplemental catalysts can be provided on honeycombs formed of any of these materials.

In a specific illustrative example of conventional catalyst bed construction, honeycomb monolith pieces of square or hexagonal cross-sectional shape are cemented together to provide a layer for a structured catalyst bed. The pieces may be 10-15 cm in cross-sectional diameter and 10 centimeters in length, and may have cross-sectional channel or cell densities in the range of 4-400 cells/cm² of honeycomb cross-section.

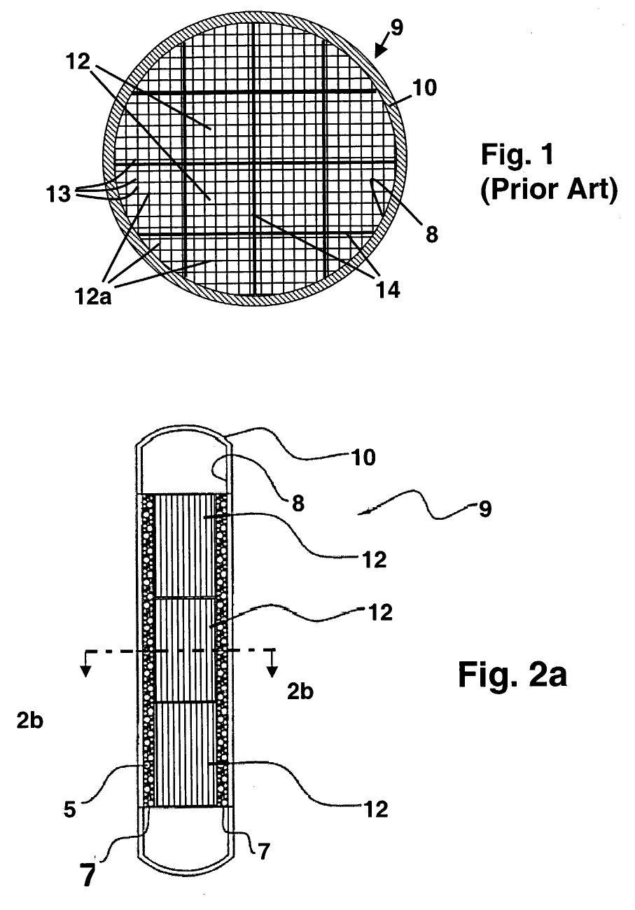

FIG. 1 of the drawing presents a schematic cross-sectional illustration of a reactor incorporating an assembled honeycomb monolith catalyst layer fabricated from just a few honeycomb sections as above described. Referring more particularly to FIG. 1, a reactor vessel 10 incorporates a structured catalyst layer comprising a plurality of ceramic honeycomb monolith sections 12 positioned therein. The longitudinal axes of the parallel honeycomb channels 13 are perpendicular to the plane of the drawing.

Monolith sections such as sections 12 may be extruded in any desired shape, but for the embodiment shown, they are extruded in a square shape, and selected ones of the square shapes, such as shapes 12a, are cut to form a circularly configured edge portion 12b. The square and rounded sections thus provided are then cemented together at joints 14 to form a honeycomb monolith layer of circular shape within housing 10. The cements may be either inorganic or organic in composition, and can be cold set at room temperature or heat-treated. Particularly useful are commercial cements filled with ceramic powders. Examples of suitable commercial cements include Resbond 794 or 989 by the Cotronics Corporation and Aremco 643 or 813A by Aremco Products Company.

In the reactor construction shown in FIG. 1, the design is intended to prevent fluid by-pass of the assembled bed at the junction of sections 12a with vessel 10. However, this can be difficult if the curvatures of sections 12a are not exact, or if inner surface 8 of vessel 10 is irregular.

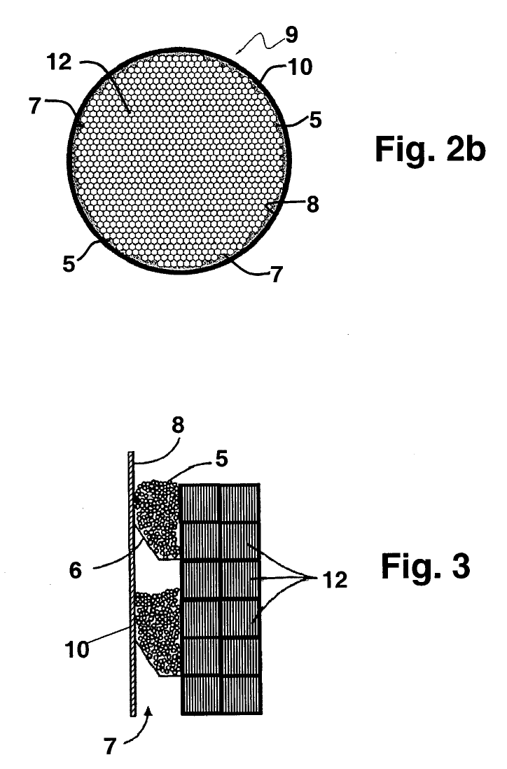

FIGS. 2a-2b of the drawing illustrate an improved reactor construction addressing this problem. FIG. 2a is an elevational cross-sectional view of a structured catalyst reactor 9 incorporating layers of monolithic honeycomb catalyst 12, while FIG. 2b is a cross-section of reactor 9 along line 2b-2b. In this reactor, the circumference of each of structured catalyst layers 12 is irregular, creating gaps 7 of varying sizes between the layers of monolith 12 and the inner wall 8 of vessel 10. To restrict the flow of fluid by-passing monoliths 12 via gaps 7 and at the same time to treat the by-passing segments of the feed stream, the gaps are filled with a particulate filler 5, in this case a packing of catalyst granules or pellets. These are suitably composed of the same catalyst employed within the channels of monolith sections 12. The particle or pellet size of bead filler 5 is not critical, but is selected in accordance with the sizes of the gaps and the processing requirements of the reaction involved. Commercial available catalyst granules of 2-4 mm in diameter are suitable in many cases.

The gap spaces surrounding assemblies of monolith catalyst stacked within reactor housings such as described can be completely filled with particulate catalyst if desired. Complete filling can provide side support for the catalyst monoliths and mitigate the effects of layer movement under vibration or with vessel expansion. However, in some cases it may be more important to avoid the settling or compaction of the catalyst particles within the reactor that can result from vibration or repeated vessel expansion and contraction. In those cases the confinement of the particulate catalyst sealing material to only specific gap locations within the reactor may be preferred, and this can be accommodated through the use of supports for the sealing material within the reactor vessel.

A preferred design for such supports is illustrated in FIG. 3 of the drawing, which is a schematic cross-sectional cutaway view of a section of a reactor vessel 10 provided with such supports. Referring more particularly to FIG. 3, supports in the form of flexible metal flanges 6, suitably formed of stainless steel or the like, extend outwardly from the outer surfaces of selected honeycomb catalyst sections 12 toward the inner surfaces 8 of vessel 10 to occupy gaps 7 between those inner surfaces and the honeycomb sections. Flanges 6, which may be supported by flange extensions (not shown) held between monolith layers in the stack, are capable of flexing inwardly or outwardly to accommodate a range of positions or diameters for monolith layers 12.

To complete a permeable seal between inner surface 8 of vessel 10 and honeycomb catalyst sections 12, flanges 6 are filled with quantities of catalyst granules 5 around the entire inner circumference of vessel 10. Thus catalyst granules 5 form a circumferential ring seal of controlled depth about the periphery of selected layers of honeycomb catalyst 12. Such ring seals restrict fluid by-pass of the bed while being sufficiently shallow to resist compaction and sufficiently flexible to accommodate dimensional changes in either honeycomb catalyst sections 12 or reactor vessel 10.

Flexible supports of the kind shown in FIG. 3, as well as other flexible support designs useful for gap closure in structured catalyst beds, may if desired be impermeable sheet structures configured to provide substantially complete filling of all reactor gap spaces in a selected layer of the bed. In those cases, the volume of the by-pass portion of the process stream may be quite low. On the other hand, designs wherein the flexible support is of perforated, meshed, or other relatively open configuration can provide for a higher volume of by-pass flow through the reactor, which higher by-pass can be advantageous from a pressure drop or fluid dynamics perspective. The determination of the best flexible support design for any particular reactor application may readily be determined by routine experiment.

The flexibility of sealing arrangements such as shown in FIG. 3 also have the beneficial effect of tending to break up any compaction of the bead seals that might occur during reactor operation, as temperature changes within the reactor cause changes in gap sizes. Further, flanges of the design shown in FIG. 3 will tend to redirect by-pass flow back toward the structured catalyst, which could be provided with spacings or openings for the reintegration of the by-pass feed. Locking means for semi-permanently connecting the bed-contacting ends of the flanges to catalyst bed sections can be provided to prevent shifting of the flanges within the reactor.

As noted above, reactors configured as herein described enable the practice of an improved method for the catalytic processing of fluid feed streams with structured catalysts. In accordance with that method, a principal portion of the fluid feed stream to be processed is transported through the structured catalyst bed within the reactor in the conventional manner, thus carrying out the desired catalytic reactions in that portion of the feed. At the same time, those portions of the feed stream that would ordinarily by-pass the structured catalyst are transported through the catalytically active fluid-permeable seals positioned in the gaps between the structured catalyst and the walls of the reactor. These seals may fill the entire space between the structured catalyst and the vessel walls, or may be provided only in selected locations to form seals at selected locations within the reactor.

The method of the invention can be used with a variety of different reactor designs to process a variety of different fluid feedstocks, but is especially well suited for use in reactors for processing gas-liquid feed streams. Reactors wherein the feed stream follows a vertical flow path rather than horizontal flow path through the structured catalyst are particularly benefited.

Fluid-permeable, catalytically active seals can be used for reactor operation in either co-current or a counter-current flow mode. The gas and liquid elements of the feed stream will pass upwardly or downwardly in the same direction through the reactor in the former flow mode, or in opposite directions in the latter flow mode. In either case, the by-pass portion of the gas-liquid feed streams can be effectively treated by the catalysts present in these seals without the need for elaborate and expensive reactor design measures to accommodate variations in structured catalyst dimensions or irregularities in reactor vessel construction.

Of course, the foregoing descriptions and embodiments of the invention are not intended to be limiting, but are merely illustrative of the various reactor designs and chemical processes that may be resorted for the practice of the invention within the scope of the appended claims.

We claim:

1. A chemical reactor having a structure comprised of a vessel enclosed by walls and containing a structured catalyst bed, said vessel further comprising at least one fluid-permeable, catalyst-containing seal positioned within one or more gap spaces between the structured catalyst bed and the vessel.

2. A chemical reactor in accordance with claim 1 wherein the structured catalyst comprises sections of monolithic honeycomb catalyst and wherein the seal includes a layer of particulate catalyst disposed within the gap spaces.

3. A chemical reactor in accordance with claim 2 wherein a support for the particulate catalyst is provided within at least one of the gap spaces.

4. A chemical reactor in accordance with claim 3 wherein the support consists of one or more flexible circumferential flange elements attached to and extending from the structured catalyst bed toward the walls of the vessel.

5. A chemical reactor in accordance with claim 2 wherein all of the gap spaces are filled with the particulate catalyst.

6. A method for catalytically processing a fluid feed stream which comprises the steps of:
transporting a principal portion of the feed stream through a structured catalyst disposed within the walls of a chemical reactor vessel, while
transporting a by-pass portion of the feed stream through a catalytically active fluid-permeable seal positioned in gaps between the walls of the reactor vessel and the structured catalyst.

7. A method in accordance with claim 6 wherein the fluid feed stream is a gas-liquid feed stream.

8. A method in accordance with claim 7 wherein the gas-liquid feed stream follows a vertical flow path through the structured catalyst bed.

9. A method in accordance with claim 8 wherein the gas-liquid feed stream is passed through the reactor in a co-current or counter-current flow mode.
